(19) United States
(12) Patent Application Publication
(10) Pub. No.: US 2018/0366982 A1
(43) Pub. Date: Dec. 20, 2018

(54) NOMADIC MEASURING SYSTEM COMPRISING A SUPPLY MODULE COMPRISING AN ELECTRICAL TORUS

(71) Applicant: Airbus Operations (S.A.S.), Toulouse (FR)

(72) Inventors: Aymeric Plo, Ambres (FR); Xavier Alquier, Grisolles (FR)

(21) Appl. No.: 16/005,322

(22) Filed: Jun. 11, 2018

(30) Foreign Application Priority Data
Jun. 12, 2017 (FR) 1755218

(51) Int. Cl. H02J 50/10; G01D 11/24

(52) U.S. Cl. CPC H02J 50/10; B64F 5/60; G01D 11/245

(57) ABSTRACT

A portable measuring system including an electronic acquisition device, at least one sensor linked to the acquisition device, and a power supply module. The power supply module includes at least one electric torus to be mounted on electrical wiring in order to generate a current by induction, and an electric power management device that delivers a voltage-stabilized current in order to power the acquisition device. An assembly includes an external data centralizer. Such a system or assembly is easy to install, has potentially unlimited autonomy, and is particularly well suited to use in an aircraft.

### CROSS-REFERENCE TO RELATED APPLICATION

This patent application claims priority to French patent application FR 17 55218, filed on Jun. 12, 2017, the entire disclosure of which is incorporated by reference herein.

### TECHNICAL FIELD

The disclosure herein relates to the field of the measurement and acquisition of data by a portable system. This type of system is used in particular to carry out one-off measurements on an installation or measurements on a mobile device such as transport mechanism or vehicle, such as for example an aircraft.

### BACKGROUND

The disclosure herein applies to numerous devices, provided that they have electrical wiring in which an electric current flows. It is applicable in particular in the aeronautical field, for measuring parameters in an aircraft in operation.

Portable data measuring systems are employed during test or development phases of an aircraft in order to collect and possibly analyze data relating to the operation thereof. These data can serve for example to check the proper operation of the aircraft, to detect anomalies, or to optimize the operation of particular devices. Such devices can also be employed on aircraft during commercial flights, for the abovementioned reasons.

The data are collected with the aid of sensors, and may for example be temperatures, pressures, speeds, strains or mechanical loads, etc.

The data measuring systems known from the prior art thus include one or more sensors, an acquisition device linked to the sensor for generating a signal representative of the measurement by the sensor and the transmission thereof, or even the application of operations to the raw signal.

The data acquisition device of portable measuring systems has to be supplied with power, and a number of solutions have been envisioned in the prior art to this end. The most autonomous devices, in particular small measuring systems, have batteries for their power supply. However, since this solution for supplying a data measuring system with electric power is limited to systems that have low power consumption, it provides limited autonomy and requires the management of replacement batteries. Therefore, the disclosure herein aims to propose a measuring system for acquiring and transmitting data measured on a device comprising an electrical installation, which can employ numerous types of sensors, is easy to install, and affords potentially unlimited electrical autonomy.

### SUMMARY

To this end, the disclosure herein relates to a portable measuring system comprising an electronic acquisition device, at least one sensor linked to the acquisition device, and a power supply module. The power supply module comprises at least one electric torus designed or configured to be mounted on electrical wiring in order to generate a current by induction, having an opening and closing mechanism for mounting the torus around the electrical wiring without it being necessary for one end of the wiring to be introduced into the torus, and an electric-power management device that receives the electricity produced by the torus and has an output that delivers a voltage-stabilized current, the output being connected to the acquisition device so as to supply it with electricity, and in that the at least one sensor is a temperature sensor, a pressure sensor, a mass sensor, a speed sensor, an acceleration sensor, or a strain sensor.

By virtue of its being powered by induced current, the measuring system has potentially unlimited autonomy as long as it is coupled to wiring (or a plurality of wirings) in which an electric current flows. The installation of the tori around wiring does not require a particular connector or heavy installation. The electric-power management device provides the acquisition device (and consequently, if appropriate, the sensors) with a stabilized voltage which prevents any malfunctioning thereof. The principle of power supply with induced current also ensures galvanic isolation. This provides great safety of use of the system.

The portable measuring system may comprise a single casing in which the acquisition device and the electric-power management device are provided. Alternatively, the portable measuring system may comprise a first casing containing the power management device and a second casing, separate from the first casing, containing the acquisition device.

In one variant of the disclosure herein, the system has a plurality of tori.

Each torus may comprise an induction coil.

The acquisition device may also have a wireless transmitter.

The portable measuring system may also have an electric power store.

The disclosure herein also relates to a portable measuring system according to one of the preceding claims and an external centralizer designed or configured to receive data from the measuring system and to process and/or save the data.

Further particular features and advantages of the disclosure herein will become more apparent from the following description.

### BRIEF DESCRIPTION OF THE DRAWINGS

In the appended drawings, which are given by way of non-limiting examples:

FIG. 1 shows a block diagram of a first embodiment of the disclosure herein;

FIG. 2 shows a block diagram, similar to the one in FIG. 1, of a second embodiment of the disclosure herein.

### DETAILED DESCRIPTION

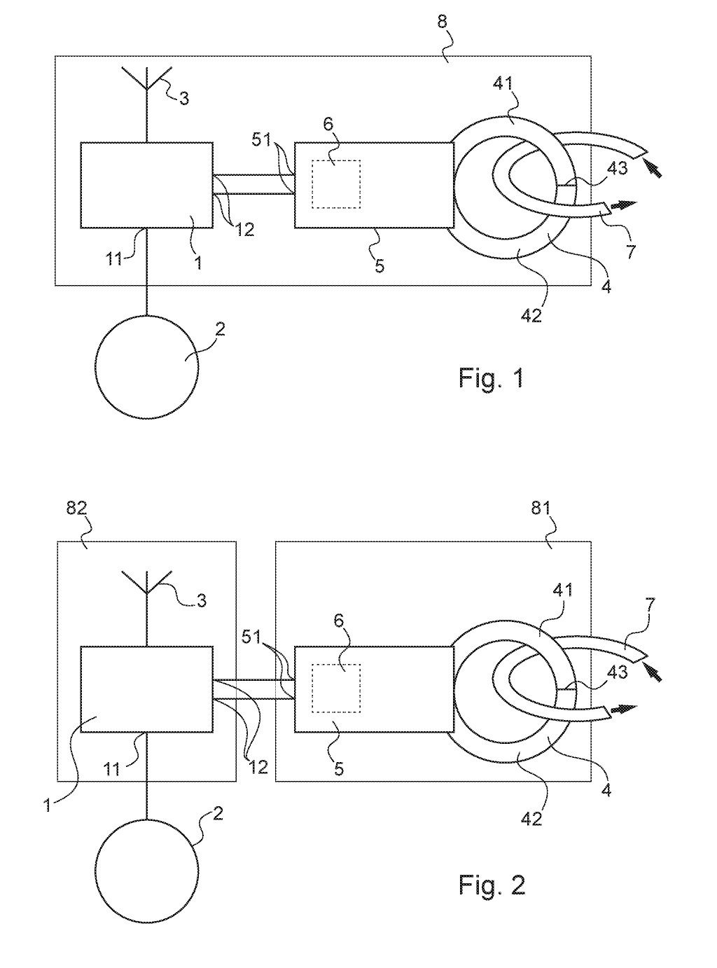

FIG. 1 shows a portable measuring system according to a first embodiment of the disclosure herein. The system has an acquisition device 1. The acquisition device is an electronic device that forms the heart of the system. It allows the collection of data, if appropriate the processing thereof, and the transmission thereof.

The system also has one or more sensors 2. The sensor 2 may be designed or configured to measure various parameters or data. It may or may not need to be supplied with electricity in order to operate. It may be passive or active, that is to say measure an item of data depending on the response to an emitted signal, in order to make the measurement. The sensor may be for example a temperature sensor, a pressure sensor, a mass sensor, a speed sensor, an acceleration sensor, a strain sensor, and/or any other type of known sensor.

The sensor 2 is connected to the acquisition device 1, and the signals output by the sensor are supplied as data input 11 of the acquisition device. The link between the sensor and the acquisition device is for example wired. The sensor may be linked permanently, that is to say in a fixed manner, to the acquisition device or be connected to the acquisition device by a removable connector. Specifically, the electronic equipment of the acquisition device may be designed for the connection of a wide variety of sensors, depending on the measurement to be made. The electronic acquisition device 1 has a wireless transmitter 3. The transmitter 3 makes it possible to emit, in accordance with a wireless connection protocol, the data output by the acquisition device. The transmission protocol may, for example, be of the Wi-Fi™ or Bluetooth™ type, this list not being exhaustive. Wi-Fi™ denotes the transmission protocols according to the IEEE 802.11 standards. Other protocols allowing a wireless radio link are conceivable, such as the ZigBee™ protocol, for example, according to the IEEE 802.15.4 standards.

The signals, which correspond to the values or the information measured with the aid of the sensor(s) 2 are thus emitted to a receiver (not shown) for processing, aggregating, and/or saving the parameters measured.

The power supply of the acquisition device is ensured by a power supply module which comprises a magnetic core 4 equipped with a coil and an electric-power management device 5.

The magnetic core has a substantially circular closed shape or a closed shape with some other geometry (for example rectangular, square) or an open shape (such as a U shape) or opening shape. The magnetic core is generally made of ferrite, so as to pick up power, by induction, from electrical wiring which passes through it and in which an electric current flows.

Electrical wiring 7 can thus be introduced into the torus 4. The electric current flowing in the wiring allows the induction of an electric current in the torus 4.

Electrical wiring 7 is understood to be one or more electrical wires suitable for an electric current to flow through. The wires of the wiring are chosen such that the instantaneous sum of the currents flowing therein is not zero. For example, with DC power, a torus may be installed on several wires in which the current flows in the same direction. For a three-phase wire, a different torus may be installed on each of the phases. The electric-power management device 5 is configured to supply a stabilized voltage. This voltage is adapted to the power supply, generally a DC power supply, of the acquisition device. To this end, the electric-power management device is configured to allow the conversion of the induced current, in real time, so as to produce a given stabilized voltage.

Thus, an output 51 of the electric-power conversion device is connected to a power input 12 of the acquisition device 1.

In order to alleviate the effects of the variations in the current in the electrical wiring 7 equipped with the torus 4, the measuring system may comprise, at the power conversion device 5 or at the acquisition device 1, an electric power reserve 6.

In the exemplary embodiment shown here, the electric power reserve 6 is associated with the power conversion device 5. The electric power reserve 6 has a relatively small capacity for powering the measuring system for a relatively short time, for example a few seconds or a few minutes, when the current flowing in the electrical wiring 7 is insufficient to allow the torus to induce sufficient electric power. The power supply by the electric power reserve 6 may replace or complement the power supply by induced current. The power reserve 6 may comprise a rechargeable battery, a capacitor or supercapacitor. A charger makes it possible to recharge the electric power reserve 6 when an induced electric power is available in excess with respect to consumption, in order that the electric power reserve 6 can supply power to the acquisition device 1 when necessary.

The device may have several tori 4. A plurality of tori has a number of advantages. Firstly, the electric power obtained by induction can be greater at the system. The power conversion device 5 makes it possible in this case to aggregate the currents induced in the tori. Furthermore, by increasing the number of tori, and by positioning them respectively on several wirings, the periods in which the current induced is zero or insufficient is reduced statistically, since it is unlikely that the flow of current in the different wirings will be cut at the same time.

In order to make it easier to fit electrical wiring in the torus 4, the latter is preferably able to be opened and closed. In particular, the torus 4 comprises an opening and closing mechanism for mounting the torus around the electrical wiring 7 without it being necessary for one end of the wiring to be introduced into the torus. For example, the torus 4 may be in the form of two elements, namely a first torus arc 41 and a second torus arc 42 that are hinged together. For example, a pivot pin of axis orthogonal to the mid-plane and situated at the junction between the first torus arc 41 and the second torus arc 42 allows the torus to be opened, and then to be put back together after electrical wiring 7 has been introduced into the torus 4.

At the junction 43 between the first torus arc 41 and the second torus arc 42, a closing device may be provided. A spring return mechanism may tend to keep or return the first torus arc 41 and the second torus arc 42 in the closed position, that is to say so as to form the complete torus. In other words, the torus 4 (or electric torus of the system) may act as a clip designed or configured to be closed over the wiring 7 for the induction of current. In particular, a constituent part of the torus (or of one of the tori), for example the first torus arc 41 or the second torus arc 42, may be linked rigidly to the power management device, such that the power management device and the torus form a clip that can be positioned on wiring.

In the embodiment of the disclosure herein shown in FIG. 1, the power supply module (which comprises the electric torus 4 and the electric-power management device 5) and the acquisition device 1 are provided in a single casing 8. The term casing should be understood broadly, that is to say including any type of mechanical protection or means that confer a physical unit on the abovementioned elements, for example a housing made of plastics material, a rigid or flexible shell, protective overmolding. The shape of the casing may vary widely, as long as it has a part in the form of a clip. This configuration provides a measuring system which, apart from the sensors which have to be positioned suitably, independently of the rest of the system, is compact and easy to use, since it can have for example the overall shape of a clip.

In the embodiment of the disclosure herein shown in FIG. 2, the power management device is provided in a first casing 81 (in the present case, the entire power supply module is included in the first casing 81), while the acquisition device is included in a second casing 82 which is separate from the first casing 81. As in the embodiment described above, the term casing should be understood broadly. This configuration provides a measuring system made up of two separate modules that are connected only in a wired manner for the power supply of the acquisition device by the power supply module. This allows easy installation, in a limited volume, of the power supply module. The acquisition device, which is remote from the power supply module, may be installed freely depending on the constraints of the equipment comprising the electrical wiring by virtue of which electricity is induced in the power supply module. The constraints of positioning the sensor(s) 2 can also be taken into account for this installation. Further parameters, such as the good wireless transmission of the data from the measuring system, can be taken into account for this installation.

Although it has been described with reference to particular embodiments, the system that is the subject of the disclosure herein is not limited to these embodiments. For example, the system can comprise several acquisition devices. This may be the case when an acquisition device belonging to a given sensor of a plurality of sensors is employed.

The measuring system thus proposed by the disclosure herein provides potentially unlimited autonomy as long as it is connected to one (or more) wirings in which an electric current flows. The installation and employment of the system are easy, notably in the embodiments in which the torus or tori is/are connected in the manner of a clip. Moreover, the measuring system does not require any maintenance (such as a battery change, for example) in order to operate.

The measuring system is particularly well suited to use in an aircraft, inasmuch as the electric network of an aircraft is spread out widely therein and conveys high currents that are likely to generate, by induction, sufficient power to supply numerous types of sensors and an associated acquisition device. The implementation of the system has no impact (or a very limited impact) on the aircraft and on the electrical architecture thereof. Specifically, since the power picked up by the device corresponds to a few milliamps at a few volts (or a few milliwatts), the drop in voltage brought about in the wiring is negligible. It can be employed both during test flights and during commercial flights without any negative consequences. During tests, the applicant has found that the system allowed, in the scope of a commercial aircraft, the power supply of an acquisition device at a few volts and a few milliamps, this being sufficient for reliable wireless transmission of the data according to low-energy transmission protocols.

One or more devices according to the disclosure herein can also be used in a current loop installed intentionally and used as power source. This solution thus makes it possible to have infinite possible positions and configurations of installations and to control the power source, independently of any fluctuations in a non-specific electric network.

The subject matter disclosed herein can be implemented in software in combination with hardware and/or firmware. For example, the subject matter described herein can be implemented in software executed by a processor or processing unit. In one exemplary implementation, the subject matter described herein can be implemented using a computer readable medium having stored thereon computer executable instructions that when executed by a processor of a computer control the computer to perform steps. Exemplary computer readable mediums suitable for implementing the subject matter described herein include non-transitory devices, such as disk memory devices, chip memory devices, programmable logic devices, and application specific integrated circuits. In addition, a computer readable medium that implements the subject matter described herein can be located on a single device or computing platform or can be distributed across multiple devices or computing platforms.

While at least one exemplary embodiment of the invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A portable measuring system comprising:
an electronic acquisition device;
at least one sensor linked to the acquisition device; and
a power supply module;
the power supply module comprising:
at least one electric torus to be mounted on electrical wiring in order to generate a current by induction, having an opening and closing mechanism for mounting the torus around the electrical wiring without it being necessary for one end of the wiring to be introduced into the torus; and
an electric-power management device to receive electricity produced by the torus and comprising an output that delivers a voltage-stabilized current, the output being connected to the acquisition device so as to supply it with electricity,
and wherein the at least one sensor is a temperature sensor, a pressure sensor, a mass sensor, a speed sensor, an acceleration sensor, or a strain sensor.

2. The portable measuring system according to claim 1, comprising a first casing containing the power management device and a second casing, separate from the first casing, containing the acquisition device.

3. The portable measuring system according to claim 1, comprising a single casing in which the acquisition device and the electric power management device are provided.

4. The portable measuring system according to claim 1, comprising a plurality of tori.

5. The portable measuring system according to claim 1, wherein each torus comprises an induction coil.

6. The portable measuring system according to claim 1, wherein the acquisition device also has a wireless transmitter.

7. The portable measuring system according to claim 1, further comprising an electric power store.

8. An assembly comprising a portable measuring system according to claim 1 and an external centralizer to receive data from the measuring system and to process and/or save the data.
